(19) United States
(12) Patent Application Publication
(10) Pub. No.: US 2006/0087187 A1
(43) Pub. Date: Apr. 27, 2006

(54) Multivariable generator and method of using the same

(75) Inventor: Richard J. Wise, Kelowna (CA)

Correspondence Address: MORGAN LEWIS & BOCKIUS LLP, 1111 PENNSYLVANIA AVENUE NW, WASHINGTON, DC, 20004, US

(73) Assignee: Magnetic Torque International, Ltd.

(21) Appl. No.: 10/973,825

(22) Filed: Oct. 27, 2004

(51) Int. Cl. H02K 21/12; H02K 31/00; H02K 39/00

(52) U.S. Cl. 310/156.32; 310/111

(57) ABSTRACT

A generator device for generating electrical energy includes a rotor having an even number of magnetic sources, and a first pair of stators, each having an odd number of coil members, the stators disposed adjacent to opposing side portions of the rotor.

### BACKGROUND OF THE INVENTION

1. Field of the Invention

The present invention relates to a generator and a method of using a generator, and particularly, to a multivariable generator and method of using a multivariable generator.

2. Discussion of the Related Art

In general, electrical generators include at least one stator having a plurality of magnets and a rotor having a plurality of coil windings to generate electrical energy. Specifically, the rotor rotates along a first axis such that the coil windings are disposed along the first axis, and the stator is disposed adjacent to the rotor, wherein as the coil windings of the stator pass through a magnetic field created by the plurality of magnets of the rotor an electrical current is induced through the coil windings.

However, due to the specific configuration of the generator, only single phase and frequency may be produced by the generator. Moreover, the specific configuration of the generator may only allow for generation of limited ranges of voltage and current.

Due to the specific relative configuration of the rotor and stator, significant amounts of heat and friction are created during operation of the generator. Thus, the lifespan of the rotor and/or stator is limited by the ability to withstand elevated temperatures for extended periods of time. Moreover, the generator requires periodic maintenance, wherein the generator must be taken off-line, disassembled, inspected, and rebuilt. Thus, the periodic maintenance is costly and time consuming.

In another generator configuration, a plate-like rotor is disposed adjacent to a plate-like stator. This configuration includes a stator having a plurality of coil windings and a rotor having a plurality of alternating polarity magnetic sources. Accordingly, as each of the magnetic sources pass by cores of each of the coil windings, an electric current is induced in the coil windings due to a spontaneous magnetic moment triggered within the cores. However, as each alternating polarity magnetic source passes by the core, the core must change its magnetic moment to be complimentary to the polarity of the magnetic source passing by the core. Thus, the repeated changing of the magnetic moment of the cores generates heat, thereby reducing the strength of the cores, reducing the effective lifespan of the cores and limiting power output of the generator; all of which reduces efficiency.

In addition, the plate-like generator configuration produces a cogging effect due to the changing magnetic fields produced by the alternating magnetic sources. This cogging effect significantly reduces efficiency of the generator and produces mechanical vibration throughout the generator.

### SUMMARY OF THE INVENTION

Accordingly, the present invention is directed to a multivariable generator and a method of using a multivariable generator that substantially obviates one or more of the problems due to limitations and disadvantages of the related art.

An object of the present invention is to provide a generator capable of generating a wide range of frequencies, voltages, and amperages.

Another object of the present invention is to provide a generator capable of having an increased operational lifespan.

Another object of the present invention is to provide a generator capable of reducing heat generation and improving efficiency.

Another object of the present invention is to provide a method of using a generator capable of producing a wide range of frequencies, voltages, and amperages.

Another object of the present invention is to provide a method of using a generator capable of having an increased operational lifespan.

Another object of the present invention is to provide a method of using a generator capable of reducing heat generation and improving efficiency.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a generator device for generating electrical energy includes a rotor having an even number of magnetic sources, and a first pair of stators, each having an odd number of coil members, the stators disposed adjacent to opposing side portions of the rotor.

In another aspect, a generator device includes a rotor having a first plurality of magnetic sources, a first stator having a first plurality of coil members, and a second stator having a second plurality of coil members, wherein the first and second stators are disposed adjacent to opposing sides of the rotor.

In another aspect, a generator device includes a rotor having a first plurality of magnetic sources, a first stator having a first plurality of coil members, and a second stator having a second plurality of coil members, wherein the first and second stators are disposed adjacent to opposing sides of the rotor.

In another aspect, a method of generating electrical energy includes rotating a rotor having an even number of magnetic sources between a first pair of stators having an odd number of coil members.

In another aspect, an apparatus for generating electrical energy includes a generator including a rotor and a first pair of stators disposed along opposing sides of the rotor, the generator producing an electrical output by rotation of the rotor with respect to the first pair of stators, and a controller for controlling the electrical output from the generator to produce the electrical energy, wherein the rotor has an even-number of magnets and the first pair of stators have an odd-number of coils.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic side view of an exemplary multivariable generator according to the present invention;

FIG. 2 is a schematic plan view of an exemplary generator stator according to the present invention;

FIG. 3 is a schematic plan view of an exemplary generator rotor according to the present invention;

FIG. 4 is a schematic view of an exemplary assembled generator according to the present invention;

FIG. 5 is a schematic view of an exemplary mounting frame according to the present invention;

FIG. 6 is a schematic view of an exemplary mounting system according to the present invention;

FIG. 7 is a schematic view of another exemplary mounting frame according to the present invention;

FIGS. 8A and 8B are schematic views of an exemplary core interconnection member according to the present invention;

FIG. 9 is a schematic view of an exemplary rotating shaft system according to the present invention;

FIG. 10 is a schematic view of an exemplary method of generating electrical energy according to the present invention;

### DETAILED DESCRIPTION OF THE PREFERRED EMBODIMENTS

Reference will now be made in detail to the preferred embodiments of the present invention, examples of which are illustrated in the accompanying drawings.

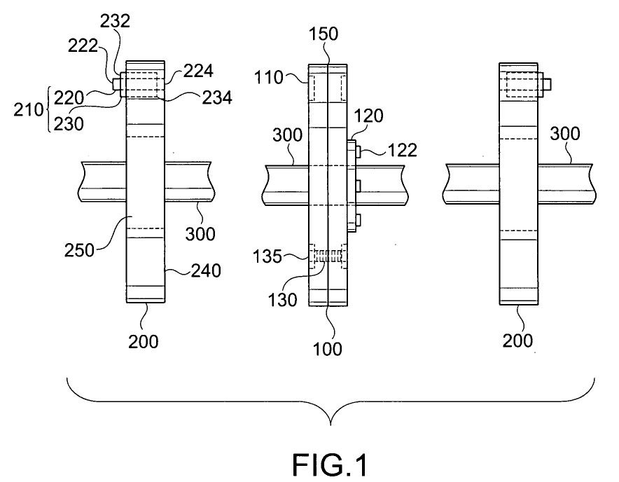

FIG. 1 is schematic side view of an exemplary multivariable generator according to the present invention. In FIG. 1, a generator may include a rotor 100 and a pair of stators 200 each disposed on opposing sides of the rotor 100. Each of the rotors 100 and the stators 200 may be made from non-magnetic materials. Alternatively, the generator may include a single rotor 100 and one stator 200 disposed at one side of the single rotor 100. The rotor 100 may include a plurality of magnetic sources 110 disposed through a thickness of the rotor 100, and the stator 200 may include a plurality of coil members 210 each disposed along a circumferential portion of the stator 200. For example, the stators 200 may include an “n”-number of the coil members 210, whereas the rotor 100 may include an “n+1”-number of the magnetic members 110. In other words, the rotor 100 may include an even number of magnetic sources 110, and each of the stators 200 may include an odd number of coil members 210. Alternatively, the rotor 100 may include an odd number of magnetic sources 110, and each of the stators 200 may include an even number of coil members 210.

As shown in FIG. 1, each of the coil members 210 may include a core portion 220 and a coil winding portion 230 disposed concentrically around the core portion 220. The core portion 220 may be disposed so as to have a first end portion 222 extending past a first end region 232 of the coil winding portion 230, and a second end portion 224 extending to be flush with an interior surface 240 of the stator 200. The core portion may be made from amorphous material, such as an amorphous ferrite material, and/or magnetite, and/or a ceramic. In addition, the coil winding portion 230 may include a second end region 234 extending into the stator 200, but offset from the interior surface 240 of the stator 200. Accordingly, diamagnetic opposition may be prevented by offsetting the second end region 234 of the coil winding portion 230 from the interior surface 240 of the stator 200. The stator 200 may further include a through-hole 250 to accommodate a rotating shaft 300 of the rotor 100. In addition, the through-hole 250 may be used for alignment of the rotating shaft 300 of the rotor 100.

Although not shown in FIG. 1, each of the coil winding portions 230 of the stator 200 may include at least two conductive leads that may be electrically connected to a control system. Accordingly, the current induced to the coiling winding portions 230 may be fed to the control system for controlling an output of the generator. Although the coil winding portions 230 may include two conductive leads, the coil winding portions 230 may include multiple “taps” having a plurality of conductive leads.

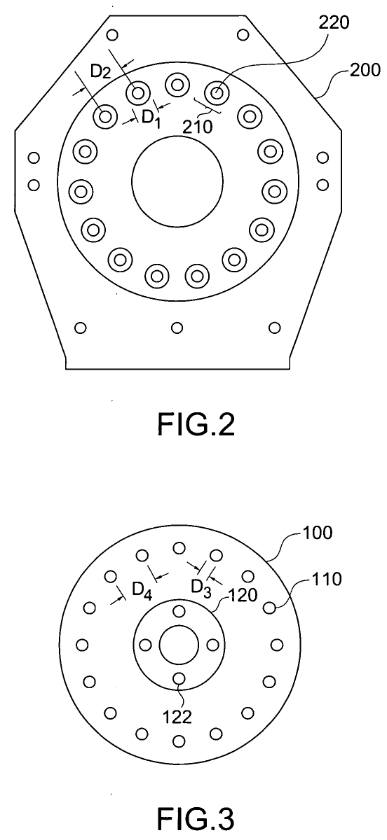

FIG. 2 is a schematic view of an exemplary generator stator according to the present invention. In FIG. 2, the coil members 210 may be distributed to be equally spaced apart around the circumference of the stator 200. For example, each of the coil members 210 may have an outermost diameter D1 and may be spaced apart from each by a distance D2 between adjacent cores 220. In addition, each of the spaced intervals between adjacent cores 220 may be about twice the outermost diameter distance D1. Accordingly, a relationship between adjacent cores 220 may be approximately represented as D2=2D1. In addition, the total number of coil members 210 may be determined, in part, by the desired output of the generator, as well as the overall physical size of the coil members 210 and the generator itself.

FIG. 3 is a schematic plan view of an exemplary generator rotor according to the present invention. In FIG. 3, a generator rotor 100 may include the plurality of magnetic sources 110 distributed to be equally spaced apart around the circumference of the rotor 100. For example, each of the magnetic sources 110 may have a diameter D3 and may be spaced apart from each by a distance D4 between adjacent magnetic sources 110. In addition, each of the spaced intervals between adjacent magnetic sources 110 may be about twice the diameter distance D3. Accordingly, a relationship between adjacent magnetic sources may be approximately represented as D4=2D3. In addition, the total number of magnetic sources 110 may be determined, in part, by the desired output of the generator, as well as the overall physical size of the magnetic sources 110 and the generator itself.

In FIG. 1, the rotor 100 may be connected to the rotating shaft 300 using a mechanical fastener system 120 using a plurality of fasteners 122. Although a single mechanical fastener system 120 is shown, mechanical fastener systems 120 may be used on opposing sides of the rotor 100. In addition, the rotating shaft 300 may be inserted through the center portion of the rotor 100. Alternatively, the rotating shaft 300 may include two separate rotating shafts extending from opposing sides of the rotor 100, wherein each separate rotating shaft may be connected to opposing sides of the rotor 100 using a pair of the mechanical fastener systems 120. As shown in FIG. 3, an outer circumference of the mechanical fastener system 120 may be relatively less than the distribution of the magnetic sources 110 spaced apart from the rotating shaft 300, thereby reducing any electromagnetic interference with the magnetic sources 110 and or with the coil members 210 of the stator 200. In addition, an outer circumference of the mechanical fastener systems 120 may be less than the through-hole 250 of the stator 200.

In FIG. 1, each of the magnetic sources 110 may fully extend through the rotor 100, with end portions of each of the magnetic sources 110 being flush with opposing outer surfaces of the rotor 100. In addition, as shown in FIG. 3, each of the magnetic sources 110 may have North N and South S magnetic poles, wherein adjacent magnetic sources 110 may have opposing N and S magnetic poles. Accordingly, since there may be an even number of magnetic sources 110 distributed along the rotor 100, then there may an equal number of N and S magnetic poles.

In FIG. 1, the rotor 100 may be formed as two separate half portions combined with a relatively thin membrane 150 therebetween, or the rotor 100 may be formed a single unitary body. In addition, as shown in FIG. 1, the rotor 100 may include a plurality of countersunk bolts 130 and nuts 135 distributed along a circumference of the rotor 100 to assist coupling the separate halves of the rotor 100 together. Accordingly, if the rotor 100 is formed of a single unitary body, then use of the countersunk bolts 130 and nuts 135 may be unnecessary.

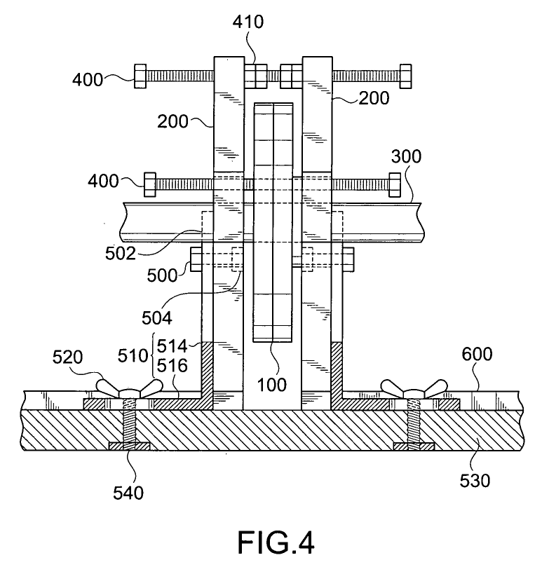

FIG. 4 is a schematic view of an exemplary assembled generator according to the present invention. In FIG. 4, both of the stators 200 are positioned to sandwich the rotor 100 with a relatively small distance between each. For example, positioning of the stators 200 with the rotor may be accomplished so as to provide a distance within a range of a few thousandths of an inch to a few tenths of an inch between the respective faces of the cores 220 (in FIG. 1) and the magnetic sources 110 (in FIG. 1). Thus, the distance between the faces of the cores 220 and the magnetic sources 110 may be adjusted by use of adjusting fasteners 400 that may be distributed along the outermost circumference of the stators 200 and extend through the stators 200. In addition, a double fastener pair 410 may used in conjunction with the adjusting fasteners 400 to provide a positively locked assembly.

In FIG. 4, a plurality of frame fasteners 500 may be provided to mechanically affix the stators 200 to a base member 530 using a plurality of base fastener pairs 520 and 540. Each of the frame fasteners 500 may extend through holes 502 at an upper portion 514 of a frame member 510 into a portion of the stators 200 to be fastened to a stator fastener 504 provided at the interior surface 240 (in FIG. 1) of the stator 200. Accordingly, a lower portion 516 of the frame member 510 may be affixed to the base member 530 using a plurality of the base fastener pairs 520 and 540.

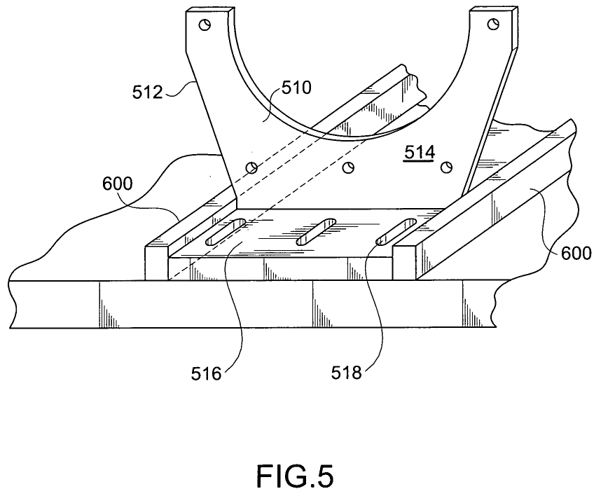

FIG. 5 is a schematic view of an exemplary mounting frame according to the present invention. In FIG. 5, a mounting frame may include a pair of side rails 600 extending mutually parallel along a first direction and affixed to the base member 530. Accordingly, interior portions of the side rails 600 may have inclined surfaces to accommodate inclined edges 512 of the frame member 510. Of course, the interior portions of the side rails 600 may have different surfaces to accommodate the inclined edges 512 of the frame member 510. The upper portion 514 of the frame member 510 may include a plurality of the holes 512 distributed to adequately support the stator 200 (in FIG. 4). In addition, the lower portion 516 of the frame member 510 may include a plurality of slots 518 that may extend along the first direction. Accordingly, the slots 518 and the base fastener pairs 520 and 540 (in FIG. 4) may provide for adjusting a position of the frame member 510 and thus, the stator 200 (in FIG. 4).

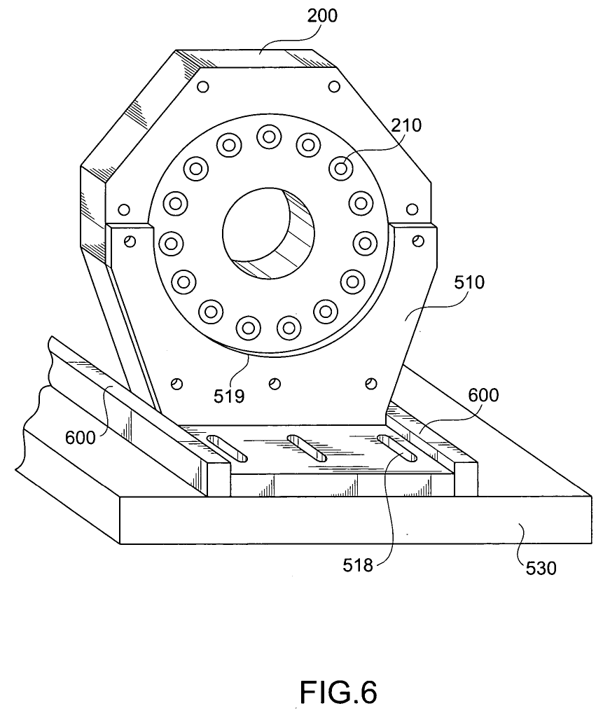

FIG. 6 is a schematic view of an exemplary mounting system according to the present invention. In FIG. 6, a mounting system may include the base member 530, the side rails 600, the frame member 510, and the stator 200. The frame member 510 includes a curved region 519 that is spaced apart from the array of coil members 210 in order to prevent any electromagnetic interference with the coil members 210.

In FIG. 6, although the stator 200 may have a first plurality of coils, the stator 200 may be replaced with a different stator having a second plurality of coils different from the first plurality of coils. Moreover, the second plurality of coils of the different stator may have a size and/or configuration different from the size and/or configuration of the stator 200. Accordingly, the electrical energy generated by the generator may be varied. For example, at least one of frequency, voltage, and amperage of the electrical energy may be varied and/or changed. Thus, according to the present invention, the generator may be capable of producing different electrical energies simply by replacing the stators, rotors, and/or controllers.

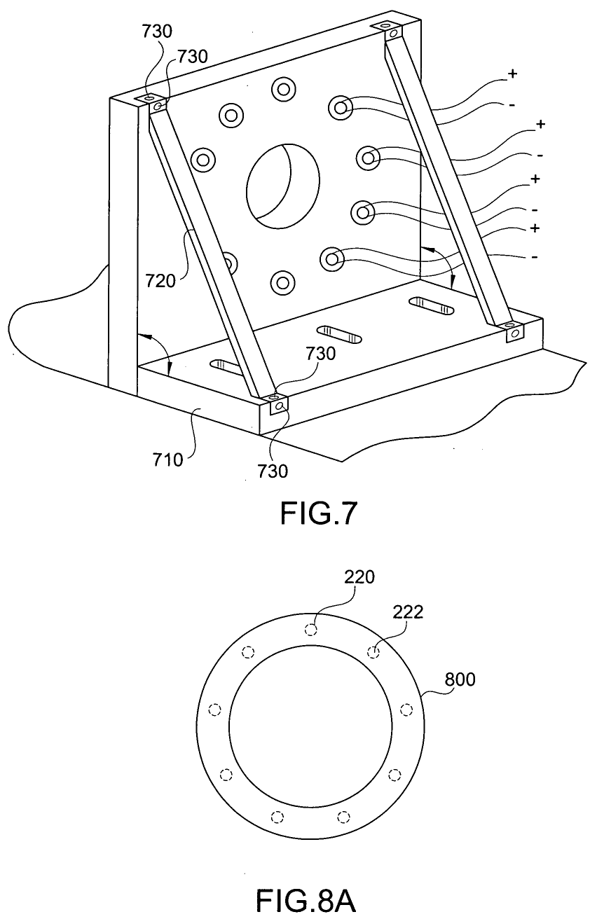

FIG. 7 is a schematic view of another exemplary mounting frame according to the present invention. In FIG. 7, a stator 200 may be formed to have a relatively square shape, as compared to the polygonal shape of the stator 200 (in FIG. 6). Of course, a stator 200 may be provided to have one of many different geometrical shapes, and is not necessarily limited to polygonal shapes. Here, the stator 200 may be mechanically fastened to a frame member 710 using a pair of connecting members 720 that extend from an end portion of the frame member 710 to an edge portion of the stator 200. Accordingly, the end portions of the connecting members 720 may be affixed to the frame member 710 and stator 200 using a plurality of fasteners.

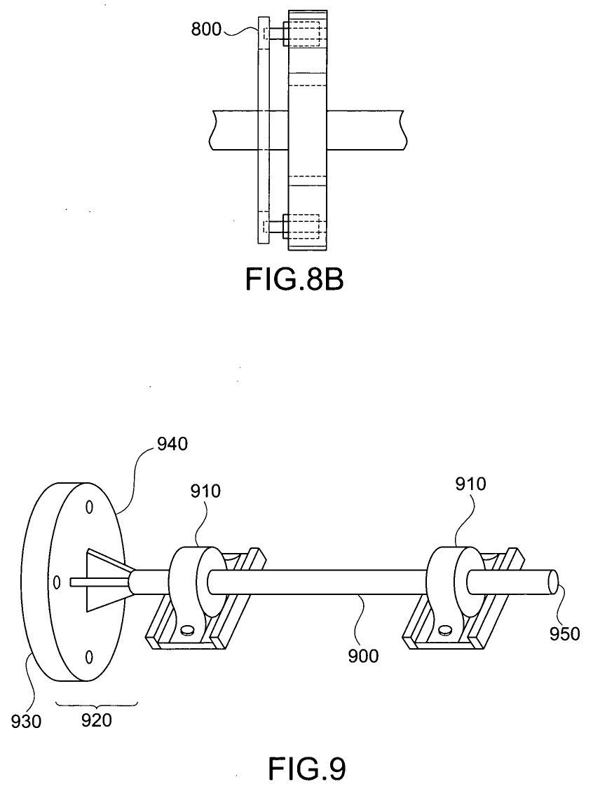

FIGS. 8A and 8B are schematic views of an exemplary core interconnection member according to the present invention. In FIG. 8A, a core interconnection member 800 may include a ring-shape wherein each of the first end portions 222 (in FIG. 1) of the cores 220 (in FIG. 1) may be electrically interconnected, thereby closing an electrical path between each of the cores 220 (in FIG. 1).

FIG. 9 is a schematic view of an exemplary rotating shaft system according to the present invention. In FIG. 9, a rotating shaft system may include a rotating shaft 900 and at least a pair of shaft supports 910 for supporting the rotating shaft 900. In addition, a first end 920 of the rotating shaft 900 may include a flywheel member 930 connected to the rotating shaft 900 using a plurality of flywheel support members 940. For example, the flywheel member 930 may be part of a separate motion control system that supplies the rotational motion to rotate the rotating shaft 900. In addition, the motion control system may make use of a torque transfer device, similar to the device disclosed in U.S. patent application Ser. No. 10/758,000, which is hereby incorporated by reference in its entirety. Thus, the rotational motion supplied to the rotating shaft 900 by the flywheel member 930 may be supplied at a second end 950 that may be affixed to the rotor 100 (in FIG. 1) to provide uniform and varied rotation of the rotor 100 (in FIG. 1) according to desired output of the generator.

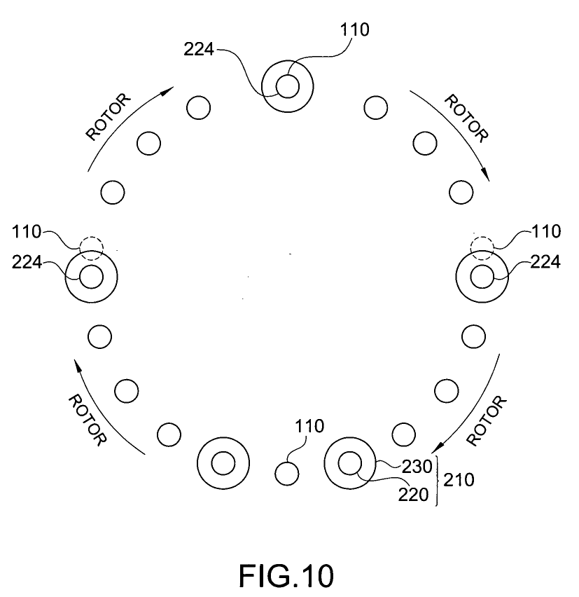

FIG. 10 is a schematic view of an exemplary method of generating electrical energy according to the present invention. In FIG. 10, a method of generating electrical energy may involve rotation of a rotor 100 (in FIG. 1), for example, between adjacent stators 200 (in FIG. 1). Accordingly, as the rotor 100 rotates, the magnetic sources 110 pass by second end portions 224 of cores 220. However, as the rotor 100 rotates, only a single magnetic source 110 is aligned with a second portion 224 of a core 220. Thus, as the rotor 100 rotates, the magnetic sources 110 become aligned with corresponding cores 220. For example, as the magnetic source 110 is aligned with the second end portion 224 of the core 220, at an upper portion of the rotor 100, then another magnetic source 110 at a lower portion of the rotor 100 may be positioned between adjacent coiling member 210. When the magnetic source 110 is aligned with the second end portion 224 of the core 220, at the upper portion of the rotor 100, then the magnetic source 110 imparts a magnetic moment to core 220 that is equal to the N/S/ polarity of the magnetic source 110. Then, a current is induced to the coiling winding portion 230 of the coil member 210, and an electrical output is produced and transmitted along conductive leads (not shown) of the coil winding portion 230. Then, the electrical output is transmitted to a controller (not shown) for further processing.

Similarly, as shown in FIG. 10, at side portions of the rotor 100, magnetic sources 110 may be coming into and out of alignment with corresponding coil members 210. Therefore, as the rotor 100 rotates, electrical energy may be sequentially produced by the coil members 210. In addition, since rotation of the rotor 100 may be varied, then the electrical energy produced by the coil members 210 may be varied. For example, frequency, voltage, and amperage of the electrical energy may be varied. Furthermore, the controller (not shown) may further vary the electrical energy produced by the coil members 210.

It will be apparent to those skilled in the art that various modifications and variations can be made in the multivariable generator and method using a multivariable generator of the present invention without departing from the spirit or scope of the invention. Thus, it is intended that the present invention cover the modifications and variations of this invention provided they come within the scope of the appended claims and their equivalents.

What is claimed is:

1. A generator device for generating electrical energy, comprising:
a rotor having an even number of magnetic sources; and
a first pair of stators, each having a first set of odd-numbered coil members, the stators disposed adjacent to opposing side portions of the rotor.

2. The generator according to claim 1, wherein each of the coil members includes an amorphous core.

3. The generator according to claim 2, wherein the amorphous core includes a first end portion flush with an interior surface of the stator, and a second end portion extending from an exterior surface of the stator.

4. The generator according to claim 3, wherein the each of the coil members includes a coil winding having a first end portion extending from the exterior surface of the stator and a second end portion extending into the stator.

5. The generator according to claim 4, where the second end portion of the amorphous core extends past the first end portion of the coil winding.

6. The generator according to claim 5, further comprising an interconnection ring coupling each of the second end portions of each of the coil members.

7. The generator according to claim 6, wherein the stator is disposed between the rotor and the interconnection ring.

8. The generator according to claim 1, wherein each of the magnetic sources extend through the rotor.

9. The generator according to claim 8, wherein outermost surfaces of the magnetic sources are flush with exterior surfaces of the rotor.

10. The generator according to claim 1, further comprising a rotating shaft extending through a through-hole of the stator and coupled to the rotor.

11. The generator according to claim 10, wherein the rotating shaft extends through the rotor and is coupled to the rotor using a fastener system.

12. The generator according to claim 11, wherein a diameter of the fastener system is less than a diameter of the through-hole.

13. The generator according to claim 12, wherein the fastener system is disposed within the through-hole.

14. The generator according to claim 1, further comprising:
a frame member coupled to the first pair of stators;
a pair of alignment rails adjacent to the frame member; and
a base member coupled to the frame member.

15. The generator according to claim 14, wherein the frame member is adjustably coupled to the base member via a plurality of slots extending along a direction of the pair of alignment rails.

16. The generator according to claim 14, wherein the first pair of stators are replaceable with a second pair of stators having a second set of odd-numbered coils different from the first set of odd-numbered coils.

17. The generator according to claim 1, further comprising a plurality of adjusting fasteners disposed along a circumference of each of the first pair of stators and extending through each of the first pair of stators.

18. The generator according to claim 17, wherein each of the adjusting fasteners position the coil members at a distance from the magnetic sources.

19. The generator according to claim 18, wherein the distance between the coil members and the magnetic sources is within a range from about a few thousandths of an inch to about a few tenths of an inch.

20. A generator device, comprising:
a rotor having a first plurality of magnetic sources;
a first stator having a first plurality of coil members; and
a second stator having a second plurality of coil members,
wherein the first and second stators are disposed adjacent to opposing sides of the rotor.

21. The generator according to claim 20, wherein a total number of the first plurality of magnetic sources is more than a total number of the first plurality of coil members and more than a total number of the second plurality of coil members.

22. The generator according to claim 20, wherein each of the magnetic sources extend through a total thickness of the rotor.

23. The generator according to claim 22, wherein end portions of each of the magnetic sources are flush with opposing surfaces of the rotor.

24. The generator according to claim 20, wherein each of the first and second pluralities of the coil members include an amorphous core and a coil winding concentrically disposed around the amorphous core.

25. A method of generating electrical energy, comprising:
rotating a rotor having an even number of magnetic sources between a first pair of stators having an odd number of coil members.

26. The method according to claim 25, wherein the electrical energy is generated as the coil members become aligned with the magnetic sources during rotation of the rotor.

27. The method according to claim 26, wherein each of the coil members include an amorphous core and a coiling winding concentrically disposed around the amorphous core.

28. The method according to claim 27, wherein a single amorphous core and a single coiling winding become aligned at a time.

29. The method according to claim 25, wherein the electrical energy has a frequency, voltage, and amperage.

30. The method according to claim 29, wherein at least one of the frequency, the voltage, and the amperage is variable.

31. The method according to claim 30, further comprising replacing the first pair of stators with a second pair of stators different from the first pair of stators to vary the at least one of the frequency, the voltage, and the amperage.

32. An apparatus for generating electrical energy, comprising:
a generator including a rotor and a first pair of stators disposed along opposing sides of the rotor, the generator producing an electrical output by rotation of the rotor with respect to the first pair of stators; and
a controller for controlling the electrical output from the generator to produce the electrical energy,
wherein the rotor has an even-number of magnets and the first pair of stators have an odd-number of coils.

33. The apparatus according to claim 32, wherein the electrical output from the generator is variable.

34. The apparatus according to claim 33, wherein the electrical output includes frequency, voltage, and amperage.

35. The apparatus according to claim 33, wherein the electrical energy produced by the controller is variable.

36. The apparatus according to claim 32, wherein the first pair of stators are interchangeable with a second pair of stators different from the first pair of stators to vary the electrical energy.
